(19) United States
(12) Patent Application Publication
(10) Pub. No.: US 2007/0169635 A1
(43) Pub. Date: Jul. 26, 2007

(54) Process and machine for preparing beverages

(75) Inventors: Denis Bienvenu, Saint Pierre Des Nids (FR); Alain Millot, Alencon (FR)

Correspondence Address: BROWDY AND NEIMARK, P.L.L.C.;624 NINTH STREET, NW, SUITE 300, WASHINGTON, DC, 20001-5303, US

(73) Assignee: SEB S.A., Ecully (FR)

(21) Appl. No.: 11/655,886

(22) Filed: Jan. 22, 2007

(30) Foreign Application Priority Data
Jan. 20, 2006 (FR) FR-06 00519

(51) Int. Cl. A47J 31/00

(52) U.S. Cl. 99/279

(57) ABSTRACT

A process and machine for preparing an infused beverage in which a pump conveys infusion water from a reservoir, through a heater and then through a packet containing a product to be infused. The beverage is prepared by a first step of placing the pump in operation, when the heater has reached a first assigned temperature, in order to deliver to the packet a first quantity of hot water for infusion, and at least one operating sequence of halting operation of the pump and generating, in the heater while the pump is halted, steam that passes through the packet, then bringing the heater to a second assigned temperature and restarting the pump in order to deliver a second quantity of infusion water once the heater has reached the second assigned temperature.

### BACKGROUND OF THE INVENTION

The present invention relates to a process and a machine for preparing hot beverages starting from a percolation, or infusion, or brewing product dose contained in a prefabricated cartridge, or packet, or pod, such as ground coffee, tea, chocolate, or a soluble powder of coffee, milk or chocolate, in order to deliver it into a collecting receptacle.

A machine for the preparation and distribution of hot beverages generally has a cold water reservoir, an electric pump, an assembly forming a water heater or boiler, and an infusion, or brewing, head that receives prefabricated packets. The packets are held in the infusion head to allow water coming from the boiler to flow through them, the resulting beverage then being delivered toward a collecting receptacle. U.S. Pat. No. 4,253,385 describes a coffee maker operating with prefabricated pods, or cartridges. The appliance includes an infusion chamber that is constructed to receive, in a sealed manner, a coffee dose which is in the form of a flexible pod, or cartridge, having a casing that is permeable to water and that encloses the coffee grounds. Infusion water flows-through the pod and then flows in the direction of a cup placed below a beverage outlet passage of the machine. This machine operates only with a coffee pod having a unique form and is, as a result, limited solely to the preparation of coffee.

U.S. Pat. No. 5,992,298 describes a coffee maker operating with measured coffee doses, employing infusion water that is heated by an instantaneous water heater before being delivered into an infusion chamber containing a coffee pod. When the infusion chamber is opened and the heating element is supplied with power, the machine produces hot water or steam through a passage for separated steam toward a receptacle containing milk. This machine can prepare other types of beverages, for which it requires attachments, such as a steam nozzle, or injector, since the machine accepts only one type of coffee dose.

Moreover, U.S. Patent Publication 2005/160918, U.S. Pat. No. 4,484,518 and European Patent document EP 0 250 810 describe methods for the preparation of infused beverages including a first infusion step performed for the purpose of pre-moistening the product contained in a pod, or cartridge, before the infusion step itself.

More particularly, U.S. Patent Publication 2004/0197444 describes a machine for the preparation of hot beverages adapted to function with several types of cartridges containing different products, notably coffee, chocolate or milk. In operation, the cartridge, initially watertight, is placed on a support and perforated by a first needle for injection of water as well as by a second needle to permit flow of the resulting beverage. When the target temperature of the heating element has been reached, a pump is actuated to deliver a small quantity of water and to achieve a pre-moistening, or wetting, of the infusion product. The pump is then halted and, after a short pre-moistening period, the pump is restarted and the infusion cycle proceeds in order to obtain an infused beverage. The machine also has a compressor that produces a purge at the end of the cycle in order to assure that the contents of the cartridge have been completely emptied. Such a machine is provided to operate with sealed cartridges having internal walls of complex form in order to be able to guarantee a correct mixing of the water and the infusion product and requiring a compressed air purge at the end of the operating cycle. Moreover, the flow rate produced by the pump must be in accordance with the type of product to be brewed. As a result, the machine and the cartridges together form a complex and costly system for the preparation of beverages.

### BRIEF SUMMARY OF THE INVENTION

The present invention provides a process and machine that overcome these drawbacks. Specifically, the present invention provides a process and machine for the preparation of beverages starting from prefabricated doses, permitting a high quality beverage to be obtained for any type of infusion product contained in a packet, using means that are simple and reliable over time.

The invention also provides a process and machine for preparing beverages starting from a dose of a product in powdered or viscous form permitting a good dissolution of the product to be infused in an economical manner with a machine having a simple structure.

A process for the preparation of infused beverages according to the invention utilizes a pump to circulate infusion water from a reservoir, through a heater and through a packet containing the infusion product. The process includes a first step of placing the pump in operation, when a first assigned temperature has been reached at the heater, in order to deliver a first quantity of hot water for infusion, and at least one intermediate step for generation of steam that is passed through the packet and is produced by the heater when the pump is halted, this step being followed by resumption of operation of the pump in order to deliver a second quantity of infusion water once a second assigned hot water temperature has been reached in the heater.

The invention also provides a machine for the preparation of infused beverages having an infusion water reservoir connected by a pump to a heater in order to deliver infusion water through a prefabricated packet containing the infusion product. The machine includes control means permitting, when the heater has attained the first assigned temperature, starting the pump in order to supply a first quantity of infusion water, and triggering at least one intermediate step of halting the pump and permitting the heater to generate steam that is caused to flow through the packet, this step being followed by resumption of operation of the pump to distribute a second quantity of infusion water when a second assigned water temperature has been reached by the heater.

The process for preparation of an infused beverage starting from a prefabricated packet of infusion product, according to the invention, already includes a first step of heating the heater to a first assigned temperature, which triggers turning on of the pump to convey cold water from the reservoir through the heater. During this first step, a certain quantity of hot water is delivered or distributed into the packet containing the infusion product. Preferably, the heater is a thermobloc having a water conduit or serpentine embedded in an aluminum block that is in contact with an electric heating resistance. This thermobloc offers the advantage of good thermal inertia, able to store heat that it then transmits rapidly to the water conduit that it encloses. In order to control the thermobloc, it is then sufficient to control the supply of electric power to the electric resistance on the basis of readings provided by a temperature sensor that is in thermal contact with the heater, and by comparing the measured temperature to an assigned temperature. The temperature sensor is in particular fixed to a wall of the thermobloc.

It has been found, during tests performed with packets containing different infusion products, that, with a continuous flow of water, particles of the product to be infused have a tendency to stick together, particularly in the case of a powder or viscous product, forming clumps of the product that sometimes attach to the walls of the packet, or, in the case of ground coffee, fine grains of the ground coffee expand and block the infusion outlet openings of the packet, thus reducing the outlet flow rate of the infused beverage.

The improvements provided by the invention relate, at least in part, to the initial delivery of a certain quantity of infusion water through the packet, and then controlling the pump in an intermittent manner, with at least one stoppage of the pump permitting the heater to reach an assigned temperature for producing steam that is then delivered to flow through the infusion product. Residual steam is then driven out by the pump when the pump is again placed in operation during the same infusion cycle in order to supply water for infusion through the packet. Steam is produced in a simple manner, by operating the pump in dependence on the temperature of water in the heater. Thus, the pump is stopped for a time to permit the temperature in the heater to rise to the steaming temperature, a temperature rise that is achieved rapidly with a thermobloc that is already in its operating stage, and thus already hot. Energy in the steam leaving the thermobloc and arriving at the interior of the packet breaks the connections among particles that have become stuck together at the interior of the packet or that have become attached to the walls, permitting a better infusion or dilution of the product. When the pump is restarted, the water flow arriving in the thermobloc pushes residual steam toward the packet along with the delivery of a new quantity of infusion water.

The assigned, or desired, temperatures are established as a function of the quantity of infusion water conveyed by the pump during each step, of the flow rate of the pump and of the thermal inertia of the thermobloc. Thus, with the same pump and the same thermobloc, the second assigned temperature is lower than the first if the second quantity of infusion water is smaller than the first in order to guarantee a constant temperature for the infusion water.

The method and machine according to the present invention provide a quality beverage by using, in a judicious manner, the same machine components, without requiring complementary devices, such as additional steam production devices, compressors, etc.

Advantageously, the pump is started when the assigned temperature of the heater has been attained and stopping of the pump is controlled on the basis of measurement by a flow meter of the quantity of water that has been delivered to the pump. The machine according to the invention includes, for this purpose, control means that trigger operation of the pump when an assigned water temperature has been achieved and that control stopping of the pump as a function of the signal received from the flow meter.

The process and machine according to the invention are highly reliable since they permit an exact measurement of the volume of water supplied to the dose of product, above all when the infusion cycle is divided into several steps.

Preferably, the invention is used with freeze-dried product, e.g., coffee, as the infusion product.

It has been found that the process according to the invention provides particular benefits when the product to be infused is a dried powder product, which easily forms clumps of particles when hot infusion water is supplied thereto. Thus, if these clumps of particles are bombarded with steam bubbles, the bonds between the particles are broken and the product is more readily dissolved in the infusion water.

Advantageously, the process according to the invention includes a first step of placing the pump into operation in order to supply hot infusion water followed by at least two intermediate steps of halting and restarting the pump. The control means of the machine permit these process steps to be carried out easily.

Numerous laboratory tests with various products available on the market have shown that in order to guarantee a good dilution of the product to be infused, there should be at least two intermediate steps of purging with steam in order to arrive at a good dissolution of a powdered product.

Preferably, the first volume, or quantity, of hot water corresponds to one-third of the total volume, or quantity, supplied to the infusion product.

The quantity of infusion water supplied to the product to be infused must be sufficient to transform the powdered product into a liquid form, but not so great that it would exit so fast as to not have diluted, or dissolved, clumps of the infusion product, formed by particles that have stuck together at the interior of the dose of product to be infused. During tests performed with different product doses, it has been found that delivery of one-third of the total volume of infusion water during the first infusion step is sufficient to dissolve a substantial part of the powdered product and to transform it into a liquid form.

Certain advantages appear when the process according to the invention comprises four intermediate steps of halting and restarting of the pump and operating the pump, after each restart, to convey one-sixth of the total volume, or quantity, distributed during a complete infusion cycle. For this purpose, the control means of the machine actuate the pump in four intermediate stopping and restarting steps in order to cause the pump to convey, after each restart, one-sixth of the total quantity distributed during an infusion cycle.

Thus, after having delivered one-third of the total quantity of infusion liquid during the first step, delivery of the remaining infusion liquid in four infusion phases, each involving the same quantity of liquid, assures a complete and uniform dissolution of the product contained in the packet, these sequences being interspersed with steam purges.

The process and the machine according to the invention are advantageously used with a packet having walls that are permeable to liquids.

Such a prefabricated packet encloses the infusion product at the interior of a liquid-permeable envelope, of a non-woven material type based on cellulose fibers. Such a packet permits the product to be better retained and dissolved before it is withdrawn from the packet, in the form of a beverage, toward a collecting receptacle, above all at low pressure values, of the order of an infusion pressure of 2 bar.

Preferably, the packet is composed of two chambers, an upper chamber containing a first infusion product communicating via at least one passage with a lower chamber containing a second infusion product.

Thus, by using a different product in each chamber, one can obtain a mixed beverage from a single packet, such as hot chocolate, cafe au lait, cappuccino, etc. According to an advantageous variant of the invention, the upper chamber contains ground coffee through which the infusion water passes first, the resulting beverage then arriving via an infusion fluid passage into the lower chamber containing a powdered milk product.

Advantageously, the infusion fluid passage is provided in the lower part of a distribution tube, or stack, formed in the central part of a wall that separates the two chambers of the packet.

In this configuration, beverage infused in the upper chamber is channeled by a type of central funnel into the lower part of the packet. When the machine delivers steam through the same tube, steam bubbles are equally channeled by the central funnel, exit from the lower part of the funnel and create turbulence by returning upwardly, in the direction of the separation wall, while thus accelerating dilution of the product in the lower chamber.

Preferably, according to the process of the invention, the first assigned temperature varies according to the initial temperature conditions of the water heater. The machine according to the invention includes the temperature sensor in thermal contact with the water heater and the control means of the machine establish the first assigned temperature detected by the sensor according to the initial conditions of the water heater.

Thus, by modifying the first assigned temperature, one obtains a satisfactory temperature for the water injected to the interior of the packet and for the beverage that is delivered into a cup. Modification of the first assigned temperature allows this result to be achieved regardless of the initial temperature conditions of the water heater. For example, the water heater will be cold at the start of production of a first beverage, and warmer during production of subsequent beverages immediately or shortly after production of the first beverage.

### BRIEF DESCRIPTION OF THE DRAWING

The invention will be better understood from a consideration of embodiments thereof disclosed by way of non-limiting example and illustrated in the attached drawings.

FIG. 1 is a partly schematic, partly cross-sectional view of a machine according to the invention.

FIG. 2 is a graph containing curves illustrating the time variations of various operating parameters of the machine during an infusion cycle.

### DETAILED DESCRIPTION OF THE INVENTION

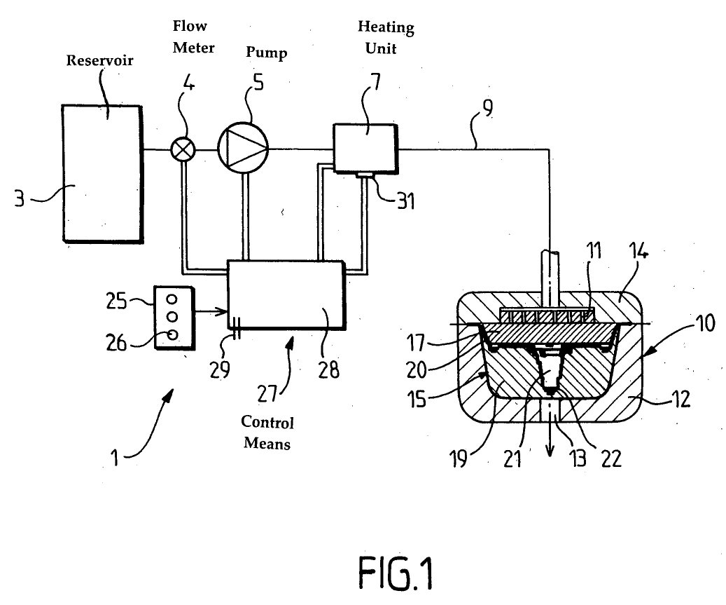

FIG. 1 shows one example of a machine 1 for preparation of infused beverages according to the invention. Machine 1 includes a water reservoir 3 connected to a pump 5 by a conduit containing a flow meter 4. Pump 5 may be, for example, an electromagnetic piston pump. Pump 5 aspirates water from reservoir 3 and conveys it into a heater 7, and particularly into a spiral conduit embedded in an aluminum mass forming a thermobloc. The thermobloc includes, in addition, a heating element in the form of an electric resistance also embedded in the aluminum mass or soldered or welded thereto. The electric resistance is connected to receive an electric current from the means provided for supplying power to the machine. Hot infusion water exiting from heater 7 arrives through a fluid conduit 9 into an infusion head 10. The volume, or quantity, of water aspirated by pump 5 is measured by flow meter 4.

An infusion head 10 is made in two parts that are moveable relative to one another between an infusion head opening position and an infusion head closing position. These two parts include, in the illustrated embodiment, a first part 12 forming a support and a second part 14 forming a lid through which water is injected. Support 12 is provided to receive a packet 15 containing a product to be infused, or brewed. When parts 12 and 14 are in the infusion head opening position, a packet 15 may be inserted into an internal reception space formed by support 12. The part 14 can then be placed on support 12, in the infusion head closing position, illustrated in FIG. 1, to form a sealed space containing packet 15. Part 14 receives the outlet end of conduit 9, which opens just above packet 15 into several infusion orifices 11. Support 12 is provided at its bottom with an orifice 13 through which the infused beverage flows toward a cup placed under orifice 13. Machine 1 can contain a single infusion head 10 or two (or more) infusion heads disposed side by side, each adapted to receive a respective packet containing an infusion product.

In the exemplary embodiment illustrated, packet 15 is composed of a flexible, water permeable envelope having an upper chamber 17 and a lower chamber 19, each chamber enclosing a respective product to be infused. Each chamber 17 and 19 may be constituted by a flexible bag, or sachet, of filter paper. Upper chamber 17 may contain uncompacted ground coffee, while chamber 19 may contain powdered milk or powdered coconut milk. The two chambers, 17 and 19, are separated by a structure in the form of a funnel 20 having a central tube, or stack, 21 with a conical form. Stack 21 has a plurality of outlet orifices 22 at its bottom and at a short distance above the bottom of chamber 19. There may be, for example, eight orifices 22 each having a selected diameter, preferably less than 1 mm, spaced about the periphery of the lateral wall of stack 21. Orifices 22 are provided to direct infusion fluid that has already passed through the substance in chamber 17 radially into lower chamber 19.

Machine 1 also includes a control panel 25 provided with a plurality of buttons 26 that are manually operable to control the operation of the machine in the manner desired by the user. Actuation of a selected one of buttons 26 provides a signal that is transmitted to a control means 27 that include a microprocessor 28 and a power connection 29. Microprocessor 28 includes, in a conventional manner, a memory storing operating programs of the machine composed of a series of program instructions. The main steps created by these programs will be described below.

Control means 27 control the operation of pump 5 and heater 7, while flow meter 4 provides control means 27 with data representing the volume, or quantity, of water aspirated by pump 5 and conveyed to heater 7. The temperature established in heater 7 is measured by a suitable temperature sensor 31, which may be constituted by a resistance element having a resistance that varies as a function of temperature, and which may have, for example, a negative temperature coefficient. Microprocessor 28 is capable of measuring the resistance of sensor 31 and of comparing the measured resistance to predetermined values corresponding to different assigned temperature values stored in the microprocessor memory.

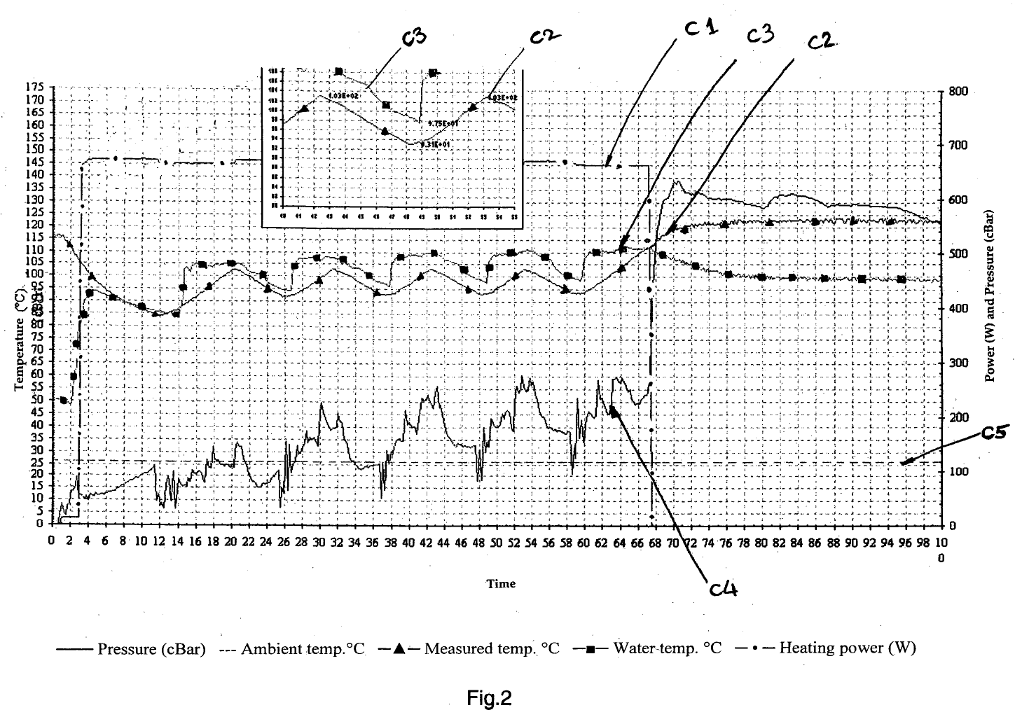

One example of the operation of the machine according to the invention is shown by the graph in FIG. 2, which includes an inset illustrating a portion of two of the curves of FIG. 2 to an enlarged scale. In FIG. 2, the curve Cl represents the power supplied to the heating resistance during a complete infusion cycle as a function of time, represented by the abscissa of the graph. The curve C2 illustrates the temperature measured by sensor 31 and curve C3 represents the temperature of water exiting from heater 7, while curve C5 represents the ambient temperature, all as a function of time. The temperature of curve C3 is measured by a thermocouple type K which is placed at the entry of the infusion head 10 for measuring the temperature of the hot infusion water arriving on the packet 15. The curve C4 represents the fluid pressure in the circuit between pump 5 and thermobloc 7, in units of 10⁻² bar. The pressure is measured by a pressure transmitter, i.e. type C-10 manufactured by Wika Tronic, which is connected in the circuit between the pump 5 and the heater 7.

When a user wishes to prepare a beverage, the user places a packet 15 into infusion head 10, closes the infusion head and turns the machine on. Heater 7 begins to be heated and control means 27 brings the heater to a first assigned temperature based on readings provided by sensor 31. By way of example, this first assigned temperature during preparation of a first beverage is established to be 120° C. Once this assigned temperature has been reached, the user can select, by depressing one of buttons 26, the type of beverage to be produced, based on the nature of the packet that was introduced into infusion head 10. For purposes of the present discussion it will be assumed that a packet 15 contains ground coffee and powdered milk. When the appropriate button 26 has been depressed, causing an input signal to be delivered to microprocessor 28, the latter controls the operation of pump 5 to deliver a first portion of the total volume of infusion water that is to be used to prepare the beverage. When flow meter 4 has provided an indication that pump 5 has delivered this first water volume portion, for example one-third of the total water volume to be used and which may be considered to correspond in the present example to 69cc, through packet 15, microprocessor 28 issues a command to halt pump 5. As shown in FIG. 2, this first step has a duration of around 12-14 seconds and the temperature measured by sensor 31 decreases during the pumping of infusion water, as shown by curve C2.

After pump 5 has been halted, heating current continues to be supplied to heater 7 so that the temperature of the water contained in the heater continues to rise, as shown by curve C3, rapidly obtaining a value of 100° C. and generating steam. The heater is controlled to arrive at and maintain a second assigned temperature, for example 100° C., during the remainder of the infusion, or beverage preparation, cycle. When the heater generates steam, the pressure in the fluid circuit between pump 5 and heater 7 rises, as shown by curve C4, and provokes a purge of conduit 9 in the direction toward packet 15. During this purge, steam bubbles trapped in the liquid passed through upper chamber 17 of packet 15, are channeled by stack 21 and exit through outlet orifices 22 in the lower part of stack 21. After arriving in lower chamber 19, which then contains a mixture of brewed coffee and powdered milk product, the steam rises toward the horizontal radially extending wall of funnel 20, creating turbulence at the interior of lower chamber 19 and in an upward direction, accelerating dilution of the powdered milk product.

Funnel 21 is impermeable, except for orifices 22.

When temperature sensor 31 detects the second assigned temperature of 100° C., microprocessor 28 again actuates pump 5 to deliver another fraction of the infusion water, for example ⅙ of the total quantity delivered during an infusion cycle in this specific example, measured by flow meter 4. Restarting of pump 5 produces a flow of hot water through conduit 9 to the interior of packet 15, which water flow rapidly pushes out the residual steam. Once this new fraction of water has been delivered, microprocessor 28 acts to again halt operation of pump 5. Upon halting of operation of pump 5, the temperature of water in the heater 7 rises rapidly, as represented by the steeply rising portions of curve C3 in FIG. 2, and thus generates steam, resulting in a new purge of conduit 9 and packet 15 with a new mixing of the mixture in lower chamber 19. It will be noted that this purge takes place just before the temperature reading produced by sensor 31 arrives at the second assigned temperature, which lasts around 5 to 6 seconds in this example, and that, due to the substantial thermal inertia of heater 7, the result is the production of steam before the sensor detects the fixed assigned temperature value.

Then, when the second assigned temperature value of the heating unit is achieved, which in this example is 100° C., microprocessor 28 again initiates operation of pump 5 in order to deliver another fraction, equal for example to ⅙ of the total infusion water quantity delivered during an infusion cycle. Then, microprocessor 28 again halts operation of pump 5. This operation is repeated several times in succession in order to deliver the remaining desired quantity of infusion water, the operating phases of pump 5 being alternated with phases of purging by generation of steam.

At the end of the complete infusion cycle, microprocessor 28 controls heating unit 7 to return to the first assigned temperature. This first assigned temperature is of the order of 120° C. for a first beverage, but can be slightly lower, for example around 110° C. for infusion cycles that follow shortly after the first cycle since the heater has stored a certain amount of heat. The heater is thus then brought to the initial starting conditions and is ready to commence a new infusion cycle.

In the example described the above, the process according to the invention includes a first phase of operation of pump 5 at a first assigned temperature for heater 7, in order to distribute ⅓ of the total quantity of infusion water, followed by halting of pump 5 until heater 7 has reached a second assigned temperature, when the pump is then controlled to restart and convey ⅙ of the total volume of infusion water, a purging phase with the steam produced by heater 7 occurring between the two consecutive actuations of pump 5. Pump 5 is then restarted again and again halted three times subsequently in order to deliver the entire quantity of infusion water and complete the infusion cycle. The infusion cycle thus comprises a first infusion phase followed by, for example, five purging phases for the steam alternating with the five pumping phases.

Other variants and embodiments of the invention can be realized without departing from the framework of the invention.

Thus, one can use a different number of purging and pump restarting phases, for example by choosing the number as a function of the structural characteristics of the heater, these characteristics including thermal inertia, capacity, inertia of the sensor, etc, as well as based on the type of packet and its contents, etc. One can, for example, deliver ⅓ of the total volume of infusion water in a first step of the infusion cycle and the remainder in two steps of purging and restarting of the pump, each step delivering ⅓ of the total infusion water volume. According to another example, ½ of the total infusion liquid volume can be delivered in a first step and the other half can be delivered after a steam purging phase.

In the same manner, not only the number of purging and pump restarting phases can be different, but also the volume delivered after each phase of purging by the steam can be different with respect to a preceding phase. Thus, one can conceive that the quantity distributed in the intermediate phases decreases with the number of intermediate purges, this involving a larger volume after the first purge, a smaller volume after the second purge, and a still smaller volume after the third purge, and so forth.

This application relates to subject matter disclosed in French Application number FR-06 00519, filed on Jan. 20, 2006, the disclosure of which is incorporated herein by reference.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A process for the preparation of an infused beverage in which a pump conveys infusion water from a reservoir, through a heater and then through a packet containing a product to be infused, said process comprising:
a first step of operating the pump, when the heater has reached a first assigned temperature, in order to deliver to the packet a first quantity of hot water for infusion; and
after said first step, at least one operating sequence composed of, in the order recited, halting operation of the pump, generating, in the heater while the pump is halted, steam that passes through the packet, then bringing the heater to a second assigned temperature, and restarting the pump in order to deliver a second quantity of hot water once the heater has reached the second assigned temperature.

2. The process of claim 1, further comprising measuring the quantity of water delivered by the pump during each operation of the pump, and wherein said first step of operating the pump includes stopping the pump when the first water quantity has been measured and said at least one operating sequence includes, after restarting the pump, again stopping the pump when the second water quantity has been measured.

3. The process of claim 2, wherein the product to be infused is a freeze-dried powder.

4. The process of claim 2, wherein said at least one operating sequence comprises at least two said operating sequences during each of which a respective second quantity of hot water is delivered.

5. The process of claim 4, wherein preparation of the infused beverage is achieved by supplying a total quantity of water to the packet during an infusion cycle and the first quantity of hot water corresponds to at least approximately 1/3 of the total quantity supplied to the product during the infusion cycle.

6. The process of claim 5, wherein said at least two operating sequences comprise four said operating sequences during each of which there is delivered a respective second quantity of hot water that corresponds to at least approximately 1/6 of the total quantity supplied to the product during the infusion cycle.

7. The process of claim 1, wherein the packet has water permeable walls.

8. The process of claim 1, wherein the packet comprises an upper chamber containing a first infusion product, a lower chamber containing a second infusion product different from the first infusion product, and at least one passage placing the upper chamber in communication with the lower chamber.

9. The process of claim 8, wherein the packet further comprises a wall separating the upper chamber from the lower chamber, the wall having a central part, and a stack formed in the central part of the wall and having a lower part in which the at least one passage is formed.

10. The process of claim 1, wherein the first assigned temperature is given a value based on initial temperature conditions of the heater.

11. A machine for the preparation of an infused beverage; said machine comprising: a reservoir; a pump; a heater; and control means connected for controlling operation of said pump and said heater, wherein:
said pump is connected for conveying water from water from said reservoir, through said heater and then through a packet containing a product to be infused; and
said control means are operative for carrying out:
a first step of placing said pump in operation, when said heater has reached a first assigned temperature, in order to deliver to the packet a first quantity of hot water for infusion; and
at least one operating sequence of halting operation of said pump and generating, in said heater while said pump is halted, steam that passes through the packet, then bringing said heater to a second assigned temperature and restarting said pump in order to deliver a second quantity of infusion water once said heater has reached the second assigned temperature.

12. The machine of claim 11, further comprising a flow meter connected for measuring the quantity of water delivered by said pump during each operation of said pump, and wherein said control means are operative to stop said pump during the first step when the first water quantity has been measured, and to again stop said pump, during the at least one operating sequence, after restarting the pump, when the second water quantity has been measured.

13. The machine of claim 12, wherein the product to be infused is a freeze-dried powder.

14. The machine of claim 12, wherein the at least one operating sequence carried out by said control means comprises at least two said operating sequences during each of which a respective second quantity of hot water is delivered.

15. The machine of claim 14, wherein, for preparation of the infused beverage, said control means are operative to supply a total quantity of water to the packet during an infusion cycle and the first quantity of hot water corresponds to at least approximately ⅓ of the total quantity supplied to the product during the infusion cycle.

16. The machine of claim 15, wherein the at least two operating sequences carried out by said control means comprise four said operating sequences during each of which there is delivered a respective second quantity of hot water that corresponds to at least approximately ⅙ of the total quantity supplied to the product during the infusion cycle.

17. The machine of claim 11, in combination with a packet containing the product to be infused, wherein said packet has water permeable walls.

18. The machine of claim 11, in combination with a packet containing the product to be infused, wherein said packet comprises an upper chamber containing a first infusion product, a lower chamber containing a second infusion product different from the first infusion product; and at least one passage placing said upper chamber in communication with said lower chamber.

19. The machine of claim 18, wherein said packet further comprises: a wall separating said upper chamber from said lower chamber, said wall having a central part; and a stack formed in said central part of said wall and having a lower part in which said at least one passage is formed.

20. The machine of claim 11, further comprising a temperature sensor in thermal contact with said heater, and wherein said control means establish the first assigned temperature based on initial temperature conditions of said heater.
